(19) United States
(12) Patent Application Publication
(10) Pub. No.: US 2010/0065350 A1
(43) Pub. Date: Mar. 18, 2010

(54) Kinematic Chain for an Electric Propulsion Vehicle

(76) Inventor: Rexhep Gashi, Givistez (CH)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/516,305

(22) PCT Filed: Nov. 23, 2007
(86) PCT No.: PCT/EP07/62733

§ 371 Date: May 26, 2009

(30) Foreign Application Priority Data
Nov. 24, 2006 (FR) 0610377

(51) Int. Cl. B60K 1/00; B60T 1/06; F16D 49/10

(52) U.S. Cl. 180/65.6; 188/18 R; 188/18 A

(57) ABSTRACT

A kinematic chain for an electric traction vehicle, the traction of the vehicle being provided by at least one rotating electric machine (3), acting on at least one wheel (2) of the vehicle by means of reduction means (5). The kinematic chain comprises a parking brake which acts between the rotor (9) and the stator of the electric machine.

The present invention relates to the ground-contact system for electric traction vehicles, in particular the kinematic chain thereof and more specifically the immobilizing function of these vehicles.

Conventionally, the immobilizing function is provided on modern vehicles by a device using the emergency brake (often referred to as the “hand brake”) which is held under tension when the vehicle is parked. This is why “parking brake” is commonly referred to, although this function does not really correspond to braking in the true sense since it does not involve deceleration. The present invention relates, therefore, to the parking brake and more strictly speaking to the immobilizing function of the vehicle.

Ground-contact systems for electric traction vehicles are known from the patent applications EP 0878332, WO2006/032669 or WO2003/065546, in which one or more electric machines drive the wheel by means of reduction means. It is known that the electric machines may also be used to slow down the vehicle and, if required, permit on this occasion the recovery of energy.

Although they may effectively be used to slow down the vehicle, it is not possible to use electric machines to provide the immobilizing function of the vehicle. More specifically, when the vehicle is permanently kept immobile using electric machines, several difficulties arise: on the one hand the electric power consumption of the machines and the temperature rise thereof may be high, especially when the vehicle is parked on an incline and, on the other hand, it would have to be possible to guarantee that the machines or the control circuit thereof do not fail, including over a long period of immobilization. These restrictions, in spite of all the advantages that may be expected therefrom (in particular from the point of view of the space taken up in the wheels), have the result that it proves impossible in the current state of technology to provide electric traction machines with the function of a parking brake. This is why electric vehicles use, as a parking brake, friction devices acting on the wheels by means of discs or drums in the manner of conventional vehicles with internal combustion engines. The principal drawback with these means is that they are heavy and bulky.

An object of the invention is thus to provide the immobilizing function of an electric traction vehicle in a compact and lightweight manner.

The invention relates, therefore, to a kinematic chain for an electric traction vehicle, the traction of the vehicle being provided by at least one rotating electric machine, acting on at least one wheel of the vehicle by means of reduction means, said kinematic chain comprising a parking brake, in which the parking brake acts between the rotor and the stator of the rotating electric machine.

Preferably, the kinematic chain comprises a disc fixed to the rotor and an immobilizing link connected to the stator, the immobilizing link gripping the periphery of the disc to prevent the rotation thereof.

Preferably, the disc comprises a peripheral groove intended to receive the immobilizing link.

Preferably, a control intended to be actuated by the driver of the vehicle is connected by a cable to the immobilizing link.

Preferably, as the cable is of the Bowden type, its sheath bears against the stator, the cable being connected to the two ends of the immobilizing link by a tie rod, the link extending substantially over the entire perimeter of the disc.

Preferably, an external groove integral with the stator receives the link when the parking brake is released.

Preferably, as the reduction means define a reduction ratio between the speed of rotation of the rotating electric machine and the speed of rotation of the wheel, the reduction ratio is greater than 10, preferably greater than 15 and the reduction means comprise two reduction stages.

Preferably, the wheel is driven by at least one rotating electric machine belonging to said wheel, preferably mounted fixedly to the axle of said wheel.

The invention also relates to a vehicle comprising at least one such kinematic chain, said vehicle also not comprising a mechanical service brake.

Further objects and advantages of the invention will become more apparent in the description which follows of a preferred embodiment. The figures respectively show:

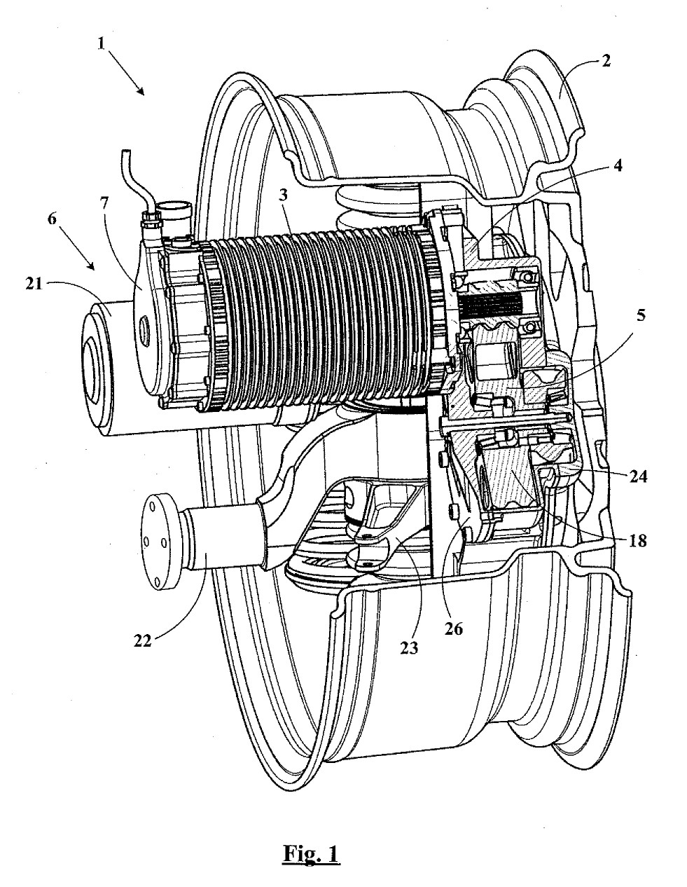

FIG. 1: a perspective view of a preferred embodiment of a kinematic chain according to the invention,

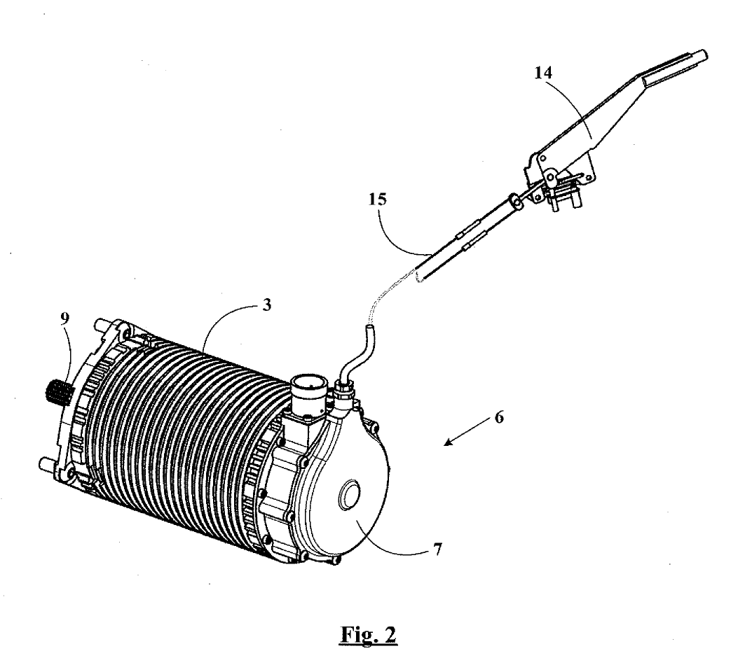

FIG. 2: a perspective view of the arrangement of the parking brake on the electric machine of FIG. 1,

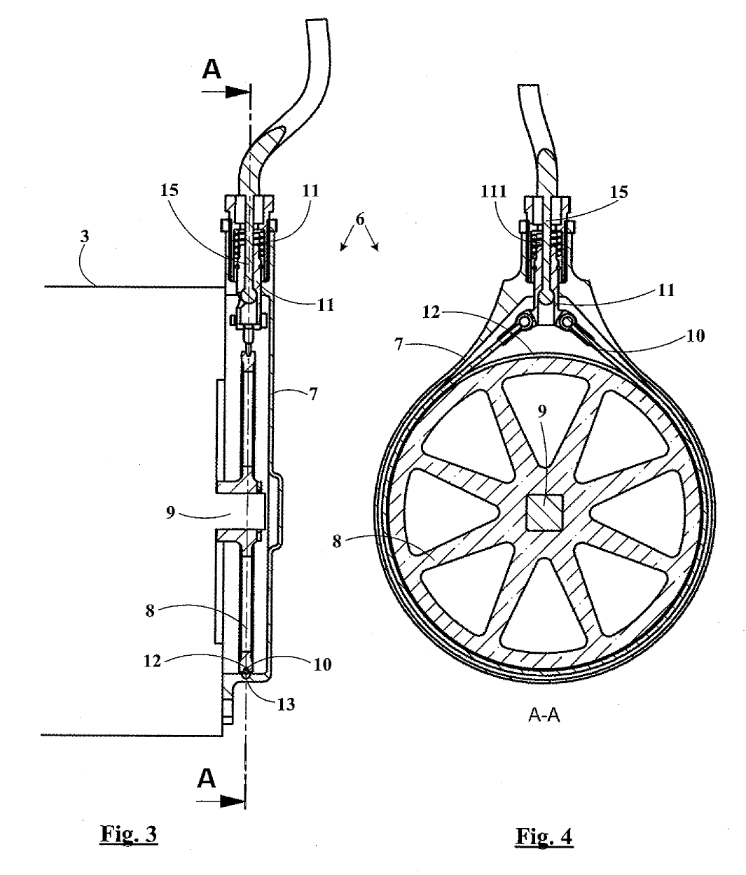

FIG. 3: a view in axial section of an embodiment of the parking brake,

FIG. 4: a view in axial section along the plane A-A of the embodiment of the parking brake of FIG. 3,

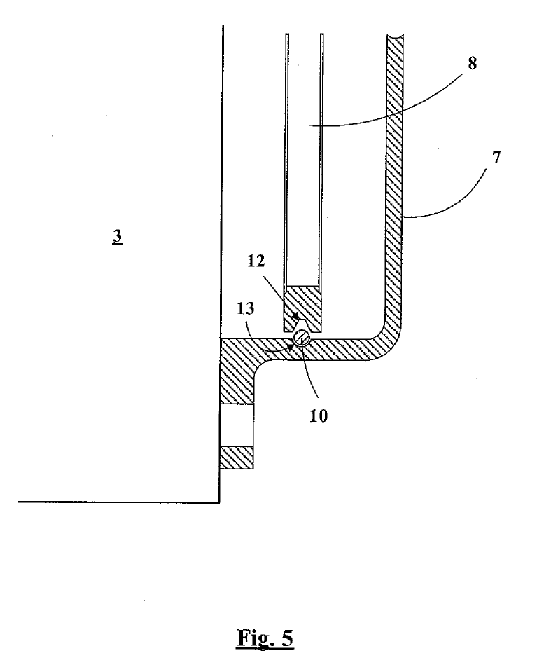

FIG. 5: a view of a detail of the lower part of the view of FIG. 3,

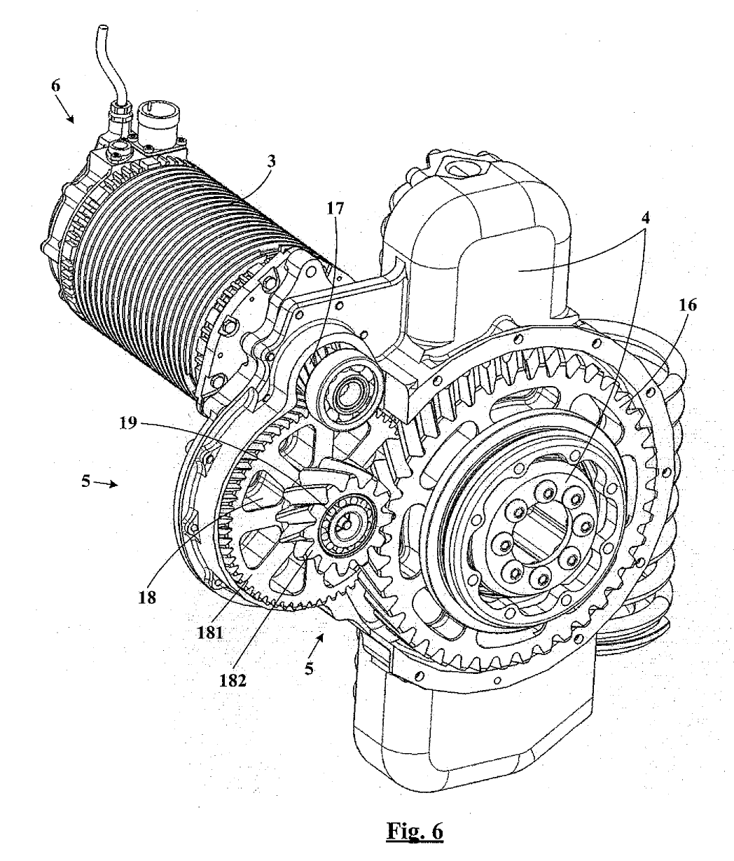

FIG. 6: a perspective view of the kinematic chain according to the invention, showing in particular its reduction means.

An example of a kinematic chain 1 according to the invention has been shown in FIG. 1. A wheel 2 and a rotating electric traction machine 3 mounted on the wheel carrier 4 are visible. The wheel is driven by the electric machine by means of reduction means 5. The wheel 2 is intended to receive a tyre, not shown.

To the rear of the electric machine 3, the parking brake 6 is located beneath its housing 7.

As is clearly visible in FIGS. 3, 4 and 5, the parking brake acts between the stator and the rotor to block the rotation of the electric machine and thus to maintain the wheel of the vehicle immobile, in an indirect but secure manner. The parking brake according to the invention thus benefits from the effect of the reduction means. The dimensions, weight and cost thereof are reduced relative to a device which might act directly in the region of the wheel, i.e. without gear reduction.

The operation of this preferred embodiment of the parking brake according to the invention will now be detailed. A disc 8 is fixed to the shaft 9 of the rotor of the electric machine 3. An immobilizing link 10 connected to the stator surrounds the periphery of the disc. The two ends of the link are held by a tie rod 11 and it is understood that, depending on the position of the tie rod and the tension which it transmits, the link locks the disc in position or leaves it free to rotate. It is understood also that it is not necessary to act with a high force on the tie rod 11 to obtain sufficient immobilizing torque of the disc due to the self-clamping effect (which is referred to also as the “capstan effect”).

As is seen more clearly in the view of the detail of FIG. 5, a peripheral groove 12, for example in a V-shape, is preferably made on the periphery of the disc and accommodates the link in the immobilized position, when the parking brake is applied. This arrangement further increases the immobilizing torque for the same force applied to the tie rod 11.

An external groove 13 is made in the housing 7 to accommodate the link 10 in its resting position, when the parking brake is released. The two grooves 12 and 13 are located opposite one another so that the immobilizing link is guided in all circumstances. Thus the path of the tie rod required to pass from the clamped position to the released position is very short, whilst guaranteeing that no friction interference occurs in the released position. Preferably, a spring 111 tends to push back the tie rod into its released position. The spring thus cooperates with the flexional elasticity of the link to keep the link pressed into the bottom of the external groove, as long as the parking brake is not applied.

The immobilizing link may be produced in different ways, provided that it is suitable, both from the point of view of its rigidity in flexion and its resistance in traction. A steel wire with a high elastic limit may, for example, be perfectly suitable.

A parking brake control, such as a lever 14, may be connected to the tie rod by a cable 15 of the Bowden type (see FIG. 2) or in any other suitable manner.

In order to prevent the driver from activating the parking brake before the vehicle is completely halted, the movement of the control may be prevented by any device which is sensitive to the speed of rotation of the electric machine 3 or of the wheel 2.

The parking brake control may also be an electric control acting directly on the tie rod 11. This control may be controlled by the driver but it may preferably be completely automated.

Preferably, the electric traction machine is further used for electrically braking the vehicle. When “braking” is referred to here, on this occasion reference is made to the service brake (in contrast to the parking brake). The service brake not only has the function of slowing down the vehicle but also of permitting its rapid and complete stop, transmitting a braking torque to the wheel so that it is possible to achieve total slippage (locking) of the wheel even though the vehicle is still moving.

In this preferred embodiment, the rotating electric traction machine 3 is simultaneously a rotating electric braking machine. It is thus capable of ensuring on its own both the braking and the driving of the wheel. This is why, according to the context, in the present application the terms “traction machine” or “traction/braking machine” are used for the same object, this object bearing the reference numeral 3 on the drawings.

Such a kinematic chain, therefore, does not comprise a mechanical service brake, i.e. the service brake does not use conventional friction braking means such as a disc or drum brake.

As seen above, the service brake is different from the parking brake which has the function of immobilizing the vehicle after stopping, for example during the absence of the driver. This function of maintaining the vehicle immobile does not particularly require any capacity for energy dissipation. It is understood, therefore, that the kinematic chain according to the invention may comprise a mechanical parking brake even though it does not have a mechanical service brake.

The reduction means comprise at least one ring gear 16 fixed to the wheel and a pinion 17 driven by the traction machine 3. The reduction ratio, i.e. the ratio between the speed of rotation of the traction machine and the speed of rotation of the wheel, is greater than 10, preferably greater than 15. This reduction ratio may be obtained directly by the meshing of the pinion 17 and the ring gear 16.

In this case, the reduction means comprise two reduction stages in the form represented here of a reducer 18 acting between the pinion 17 and the ring gear 16. The reduction ratio determined by the reduction means is specific and fixed.

The reducer 18 comprises in this case two coaxial and integral toothed wheels 181 and 182, the primary wheel 181 meshing with the pinion 17 of the traction/braking machine and the secondary wheel 182 (of reduced diameter relative to the primary wheel) meshing with the ring gear 16. Preferably, the reducer 18 is guided relative to the wheel carrier 4 by means of a pair of rolling bearings with conical rollers 19 and an axial screw 184 absorbs the axial component of the forces transmitted by the conical rolling bearings to their supports.

Preferably, the teeth of the primary and secondary wheels, of the pinion and of the ring gear are helicoidal. The reduction means have to remain reversible, i.e. they have to be able to rotate both in one direction and in the other but also to transmit a torque from the traction/braking machine to the wheel and from the wheel to the traction/braking machine with acceptable efficiency. Preferably, the angles of the teeth of the primary and secondary wheels are oriented in the same direction. This feature makes it possible to minimize the axial force acting on the reducer and thus on the wheel carrier.

Preferably, as shown in the figures, the axis of the traction/braking machine 3, the axis of the reducer 18, and the axis of rotation of the wheel are parallel.

Preferably, the suspension of the ground-contact system is a vertical sliding suspension system actively controlled by a second rotating electric machine 21 according to the teaching of the document WO2006/032669.

The support 22 is intended to connect the ground-contact system to the body of the vehicle, either rigidly or by a connection permitting additional degrees of freedom such as for example a variation in the height of the body and/or of the camber of the wheels (for example according to the teaching of the patent application EP1616731), a filtering of the vibrations or a horizontal suspension.

The steering of the wheel relative to the body of the vehicle and thus relative to the support 22 preferably takes place about a vertical pivot axis located in the centre of the suspension slide (see the steering arm 23 in FIG. 1).

It is clearly illustrated in FIG. 5 that the wheel carrier 4 constitutes a housing accommodating all the reduction means (ring gear 16, pinion 17 and reducer 18). This housing is closed by a first sealed cover 24 on the side of the wheel disc and by a second sealed cover 26 on the inside. All the gears are thus contained in the housing. The housing may contain a suitable lubricant. Also seen clearly in this figure is the mounting of the pinion 17 and of the reducer 18 in said housing.

The braking or traction force available depends on the torque available on the shaft of the machine 3, the reduction ratio and the radius of the wheel. For example, for a machine capable of generating a torque of 90 N·m, a reduction ratio of 17 and for a wheel radius of 300 mm, the traction force or braking force may reach 5100 N. This force is sufficient to utilise 100% of the potential grip of a tyre bearing a load of 5000 N when the grip coefficient is equal to 1. These load and grip conditions are typical for a modern passenger vehicle. The sole purpose, however, of this example is to establish orders of magnitude; it is not intended to limit the application of the invention to a type or a category of vehicle. It is understood that this force is denoted “traction force” when it acts in the direction of displacement of the vehicle and “braking force” when it acts against the direction of displacement of the vehicle, whether the vehicle is displaced forwards or backwards. In reality, they are one and the same force, both originating from the torque produced by the machine 3. The braking power may thus be sufficient to be able to lock the wheels of the vehicle. Naturally, the complete locking of the wheels is not the best way of stopping a vehicle but this reference is intended to facilitate the understanding of the invention.

A four-wheeled vehicle may thus in practice be provided with four ground-contact systems according to the invention and completely dispense with a mechanical service brake. A vehicle according to the invention may also use only two such ground-contact systems. According to the invention, it is also conceivable to use two or more traction/braking machines inside each wheel. One advantage with this selection may be the possible redundancy of traction means and, above all, braking means.

Moreover, the absence of the conventional mechanical braking member (see disc and clamp in the application EP 0878332) substantially simplifies the maintenance of the vehicle by eliminating the periodic operations for replacing pads and discs. Amongst the advantages of eliminating the conventional hydraulic braking members may be cited further the elimination of any residual friction of the pads (it is known that this friction consumes a not inconsiderable part of the energy required for the operation of a vehicle with conventional braking). The elimination of the thermal stresses produced on the ground-contact system by conventional hydraulic braking members and the elimination of the damage associated with dust produced by the wear of the pads and discs may also be cited as advantages.

It is understood that the small spatial requirement of the parking brake according to the invention is a significant advantage since a specific advantage of this type of ground-contact system is to integrate all the functions in a reduced volume in the vicinity of the wheel. Naturally, the parking brake according to the invention may also be used in a ground-contact system where the electric machine 3 is offset, i.e. not fixed to the wheel carrier 4. More specifically, if the electric traction/braking machine is fixed to the body of the vehicle and drives the wheel by means of conventional transmissions, the function of the parking brake according to the invention is not changed thereby. The same applies to a vehicle which might use a central electric machine driving a plurality of wheels by means of a plurality of conventional transmissions.

The different figures show a preferred embodiment of the invention in which the parking brake acts on the rotor, i.e. on the shaft of the electric machine. For example, for reasons of the spatial requirement, however, the choice may be made to apply the principle of the invention by blocking in rotation an additional shaft meshing with the ring gear 16 or with the reducer 18. This additional rotating shaft is thus activated by the reduction means of the traction/braking machine.

Primarily disclosed here is a preferred embodiment of the invention in which a metal wire is used cooperating with a peripheral groove of a disc. The person skilled in the art understands that the principle of the invention may be applied in a similar manner by using other means, such as for example a textile cord acting on a drum connected to the rotor or a simple pin which might be mobile between a position in which the rotor is free to rotate and a position in which the rotor is immobilized relative to the stator.

1. A kinematic chain for an electric traction vehicle, the traction of the vehicle being provided by at least one rotating electric machine, acting on at least one wheel of the vehicle by means of reduction means, said kinematic chain comprising a parking brake, wherein the parking brake acts between the rotor and the stator of the electric machine.

2. The kinematic chain according to claim 1, comprising a disc fixed to the rotor and an immobilizing link connected to the stator, the immobilizing link gripping the periphery of the disc to prevent the rotation thereof.

3. The kinematic chain according to claim 2, wherein the disc comprises a peripheral groove adapted to receive the immobilizing link.

4. The kinematic chain according to claim 2, comprising a control adapted to be actuated by the driver of the vehicle, the control being connected by a cable to the immobilizing link.

5. The kinematic chain according to claim 4, wherein the cable is of the Bowden type, its sheath bearing against the stator, the cable being connected to the two ends of the immobilizing link by a tie rod, the link extending substantially over the entire perimeter of the disc.

6. The kinematic chain according to claim 2, wherein an external groove integral with the stator receives the link when the parking brake is released.

7. The kinematic chain according to claim 1, wherein the reduction means define a reduction ratio between the speed of rotation of the rotating electric machine and the speed of rotation of the wheel, the reduction ratio being greater than 10.

8. The kinematic chain according to claim 7, wherein the reduction ratio is greater than 15 and the reduction means comprise two reduction stages.

9. The kinematic chain according to claim 1, wherein the wheel is driven by at least one rotating electric machine belonging to said wheel.

10. The kinematic chain according to claim 9, wherein said rotating electric machine is mounted fixedly to the axle of said wheel.

11. A vehicle comprising at least one kinematic chain according to claim 1, said vehicle further not comprising a mechanical service brake.
